(19) United States
(12) Patent Application Publication
(10) Pub. No.: US 2011/0286616 A1
(43) Pub. Date: Nov. 24, 2011

(54) HEARING DEVICE WITH A PASSIVE UNIT SEATED DEEP IN THE AUDITORY CANAL

(75) Inventors: FRANK BECK, SPARDORF (DE); FRANK NAUMANN, ERLANGEN (DE); UWE RASS, NURNBERG (DE)

(73) Assignee: SIEMENS MEDICAL INSTRUMENTS PTE. LTD., SINGAPORE (SG)

(21) Appl. No.: 13/113,273

(22) Filed: May 23, 2011

(30) Foreign Application Priority Data
May 21, 2010 (DE) 10 2010 021 173.7

(51) Int. Cl. H04R 25/00

(52) U.S. Cl. 381/315

(57) ABSTRACT

Hearing devices and, more particularly hearing aids, can be inserted into the auditory canal in an improved fashion. A hearing device has a first unit, which can be completely inserted within a human auditory canal. The first unit has a first housing into which a sound-recording element, a receiver and, connected therebetween, an amplifier are integrated. The hearing device moreover has a second unit, which is outside of the first housing and can be inserted into the human auditory canal in addition to the first unit. The second unit is galvanically connected to the first unit and configured for wireless energy absorption and for supplying the first unit with current. Hence, the first unit, together with the second unit, does not require a battery as an energy source and can thus have a smaller configuration, and therefore it can optionally be introduced further into the auditory canal.

### CROSS-REFERENCE TO RELATED APPLICATION

This application claims the priority, under 35 U.S.C. §119, of German application DE 10 2010 021 173.7, filed May 21, 2010; the prior application is herewith incorporated by reference in its entirety.

### BACKGROUND OF THE INVENTION

### Field of the Invention

The present invention relates to a hearing device with a unit, which can be completely inserted within a human auditory canal and which has a housing into which a sound-recording element, a receiver and, connected there-between, an amplifier are integrated. Here, a hearing device is understood to mean any sound-emitting instrument that can be worn in or on the ear, more particularly a hearing aid, a headset, headphones and the like.

Hearing aids are portable hearing devices used to support the hard of hearing. In order to make concessions for the numerous individual requirements, different types of hearing aids are provided, e.g. behind-the-ear (BTE) hearing aids, hearing aids with an external receiver (receiver in the canal [RIC]) and in-the-ear (ITE) hearing aids, for example concha hearing aids or canal hearing aids (ITE, CIC) as well. The hearing aids listed in an exemplary fashion are worn on the outer ear or in the auditory canal. Furthermore, bone conduction hearing aids, implantable or vibrotactile hearing aids are also commercially available. In this case, the damaged sense of hearing is stimulated either mechanically or electrically.

In principle, the main components of hearing aids are an input transducer, an amplifier and an output transducer. In general, the input transducer is a sound receiver, e.g. a microphone, and/or an electromagnetic receiver, e.g. an induction coil. The output transducer is usually configured as an electroacoustic transducer, e.g. a miniaturized loudspeaker, or as an electromechanical transducer, e.g. a bone conduction receiver. The amplifier is usually integrated into a signal-processing unit. This basic configuration is illustrated in FIG. 1 using the example of a behind-the-ear hearing aid. One or more microphones 2 for recording the sound from the surroundings are installed in a hearing-aid housing 1 to be worn behind the ear. A signal-processing unit 3, likewise integrated into the hearing-aid housing 1, processes the microphone signals and amplifies them. The output signal of the signal-processing unit 3 is transferred to a loudspeaker or receiver 4, which emits an acoustic signal. If necessary, the sound is transferred to the eardrum of the equipment wearer using a sound tube, which is fixed in the auditory canal with an ear mold. A battery 5, likewise integrated into the hearing-aid housing 1, supplies the hearing aid and, in particular, the signal-processing unit 3 with energy.

ITE hearing aids and CIC hearing aids are preferably placed deep into the ear canal or the auditory canal, in the vicinity of the eardrum. This is because, on the one hand, it should not be possible to see that a hearing aid is being worn and, on the other hand, a better sound quality can be achieved if there is a small volume between the receiver and the eardrum. However, in this case there is a problem in that a hearing aid with all its components has a certain minimum volume but should nevertheless fit into a small ear canal.

There is significant variation in the individual size of the auditory canal. Currently, it is not possible to fit the hearing-aid deep into all ear canals (deep-fit). As the size of the hearing aid or hearing device increases, it becomes less and less suitable for a deep seat in the auditory canal; this is even more pronounced in the case of small auditory canals.

International patent disclosure WO 2008010716, corresponding to U.S. patent disclosure No. 2009/0262964, discloses a hearing aid in which the processor unit is situated outside of the auditory canal. The processor unit is connected to the part seated deep in the auditory canal by a cable.

Moreover, the international patent disclosure WO 04010734 and U.S. Pat. No. 6,724,902 disclose a seal deep in the auditory canal, with the signal-processing components being seated in the outer auditory canal. A sound tube ensures a connection between the two units.

Published, non-prosecuted German patent application DE 10 2006 024 411 A1, corresponding to U.S. patent disclosure No. 2007/0274553, discloses a hearing device with a first component, which can be worn in the auditory canal and has a reception unit for wireless reception of signals. It moreover has a second component, which is structurally separated from the first component, can likewise be worn in the auditory canal, and has a transmission unit for wireless transmission of signals and/or energy to the reception unit in the first component. The first component can be configured without a battery. The second component, seated closer to the outside in the auditory canal, can easily be removed from the auditory canal for replacing the battery.

### SUMMARY OF THE INVENTION

It is accordingly an object of the invention to provide a hearing device with a passive unit seated deep in the auditory canal which overcomes the above-mentioned disadvantages of the prior art devices of this general type, which has a higher probability of also being able to be inserted into a smaller auditory canal.

According to the invention, the object is achieved by a hearing device with a first unit, which can be completely inserted within a human auditory canal. The first unit has a first housing into which a sound-recording element, a receiver and, connected therebetween, an amplifier are integrated. A second unit, which is outside of the first housing and can be inserted into the human auditory canal in addition to the first unit, is galvanically connected to the first unit. The second unit is configured for wireless energy absorption and for supplying the first unit with current.

Advantageously, the passive, physically independent part of the hearing device can have a smaller configuration compared to the prior art because this part of the hearing device does not require its own source of energy. Since this part of the hearing device can therefore have a smaller configuration, it can be inserted further into an auditory canal.

The sound-recording element is preferably configured as a silicon microphone. Such silicon microphones are robust and can have very small designs.

In one embodiment, the second unit, i.e. the unit for wireless energy absorption, is also configured for wireless data transmission. As a result, the wireless transmission serves a number of purposes.

More particularly, the second unit can be configured such that it wirelessly receives commands from the outside and the received commands can be carried out by the first unit. As a result, a part of a hearing aid inserted deep into the auditory canal can be actuated wirelessly from the outside. Specifically, it may be expedient to configure the second unit for wireless reception of adjustment parameters for the first unit.

In a further embodiment the hearing device contains a third unit, which is physically separated from the first and second unit, can be worn in or on the outer ear, and is configured for wireless emission of energy to the second unit. This third unit is easily accessible from the outside, and so, for example, removal from the ear for charging or replacing the battery is possible without much effort and, more particularly, without removing the part of a hearing aid seated deep in the auditory canal. Alternatively, the energy-supplying third unit may also be worn at a different place on the body.

In a further embodiment, the third unit can have a processor, with a bidirectional data interchange between the first unit and the third unit being made possible via the second unit such that raw data from the first unit can be processed in the third unit and the processed data can be transmitted back to the first unit. As a result the part of the hearing device seated deep in the auditory canal may have an even smaller configuration. Moreover, the part of the hearing device seated deep in the auditory canal then requires less energy, which has to be transmitted via the wireless interface.

Furthermore, the second unit can have an annular antenna with an air-cored coil. This can be inserted coaxially into the auditory canal and can moreover serve as a holding element for the first unit.

In a further exemplary embodiment, the second unit has a casing with a handle section, by which the second and first unit can be pulled out of the human auditory canal. As a result, there is no need for special tools for removing the passive part of the hearing device from the auditory canal.

Other features which are considered as characteristic for the invention are set forth in the appended claims.

Although the invention is illustrated and described herein as embodied in a hearing device with a passive unit seated deep in the auditory canal, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration of a basic sketch of a hearing aid according to the prior art;

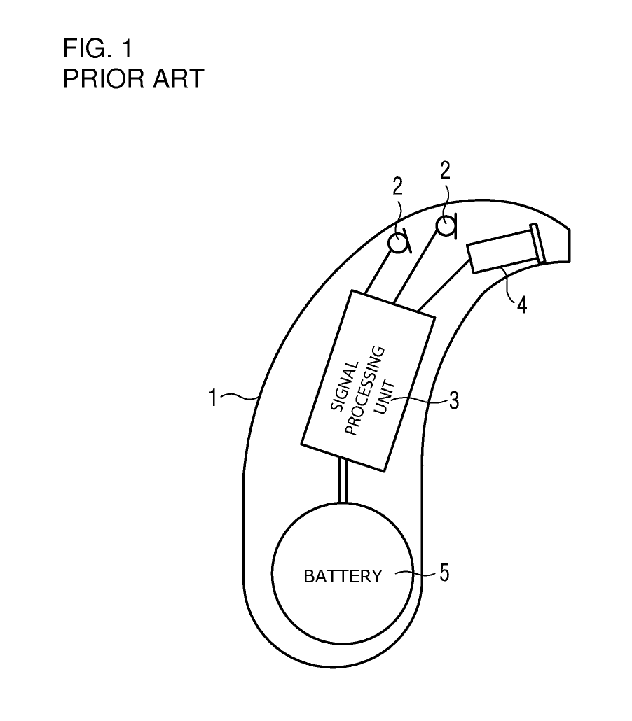

FIG. 2 is an illustration showing a hearing device with a processor in a passive part according to the invention; and

FIG. 3 is an illustration showing a hearing device with a processor in the energy-supplying unit according to the invention.

### DETAILED DESCRIPTION OF THE INVENTION

The exemplary embodiments explained in more detail below constitute preferred embodiments of the present invention.

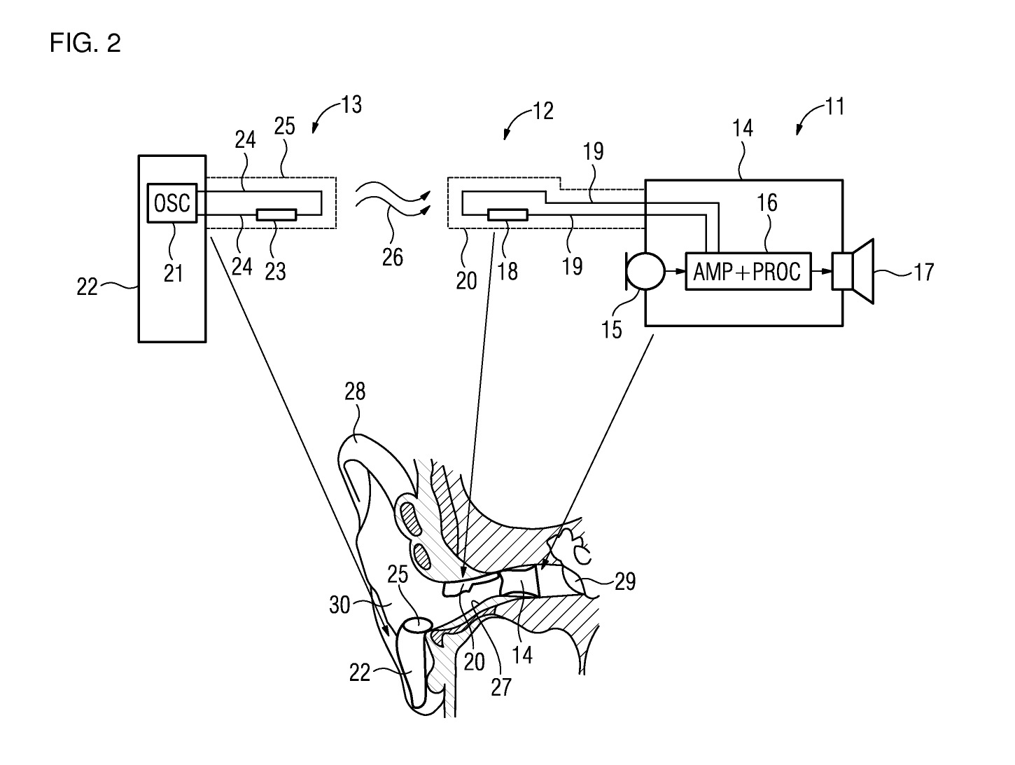

Referring now to the figures of the drawing in detail and first, particularly, to FIG. 2 thereof, there is shown, as a hearing device according to the invention, a two-part hearing aid in a schematic view. Illustrated below the schematic view is a cross section through a human auditory canal, into, or on which, implemented components of this hearing aid are placed.

To be precise, FIG. 2 shows a first unit 11, which has the actual signal-processing components of a hearing aid. Connected galvanically to the first unit 11, there is a second unit 12, which is configured for wireless energy absorption and for supplying the first unit 11 with current. The second unit 12 obtains the energy from a third unit 13, which is physically separated from the second unit 12.

The first unit 11 has a housing 14. The housing 14 houses a sound-recording element, in this case a microphone 15 (more particularly a silicon microphone). The microphone 15 signal is supplied to an amplifier unit 16, which also contains a processor. The processor can set the gain in a conventional fashion and specific filtering may be carried out. The output signal from the amplifier unit 16 is supplied to a loudspeaker or receiver 17, which converts the processed and amplified signal into sound.

The first unit 11 does not have its own energy source; in particular, it does not have its own battery. Hence, it has a purely passive design. Nevertheless, the first unit 11 has to be supplied with energy. In this case, the energy is supplied indirectly by the second unit 12, which is physically joined to the first unit 11. The second unit 12 has an electromagnetic coupling element, by which energy can be obtained from an electromagnetic field. In the present example, the second unit 12 has a coil 18, which is configured for inductive energy absorption. However, the second unit 12 may also be equipped with an antenna, by which electromagnetic energy may be absorbed.

In the example shown in FIG. 2, the coil 18 is connected to the first unit 11, and more particularly to the amplifier unit 16, by two conductors or cables 19. By way of example, the DC voltage required for supplying the individual components of the first unit 11 with current is obtained in the multifunctional amplifier unit 16 from the alternating signal obtained from the coil 18. In order to protect and insulate the antenna 18 and the lines 19, the second unit 12 has a casing 20, which is mechanically coupled to the housing 14 of the first unit 11. The casing 20 may be a housing, a simple sheath or a potting compound that surrounds the coil 18 and the lines 19.

The third unit 13, which is physically separated from the second unit 12, provides the energy required for the first unit 11. To this end, the third unit 13 has, for example, a battery (not illustrated in any more detail in FIG. 2), and so the third unit may also be referred to as a battery unit. In order to be able to transmit the battery energy wirelessly, the third unit 13 has an inverter, which, in a simplified fashion, is illustrated as an oscillator 21 in FIG. 2. The inverter and the battery (not illustrated in any more detail) are in this case housed in a housing 22 of the third unit. A coil 23, which is connected to the oscillator 21 with the aid of lines 24, is routed out of the housing 22. The coil and the lines are in turn surrounded by a casing 25 for insulation and protection purposes. The casing 25 may once again be a housing, a simple sheath or a potting compound.

For the purpose of coupling 26, the coil 23 of the third unit 13 generates an alternating magnetic field, which induces a corresponding AC voltage in the coil 18 of the second unit 12. The energy required for the first unit 11 can be obtained from the induced voltage. The two coils 18 and 23 are directed at one another for inductive coupling that is as efficient as possible. Alternatively, the energy may also be transmitted by an electric field (capacitive transmission) or by any other electromagnetic fields.

The lower section of FIG. 2 illustrates a cross section through the auditory canal of a human ear. The hearing aid, illustrated schematically at the top of FIG. 2, is positioned in an auditory canal 27 and in the auricle 28. The individual units 11, 12, and 13, and/or the casing 20, 25 or housing 14 thereof, have possible realistic shapes. The first unit 11 has been inserted very deeply into the auditory canal 27 and is situated directly in front of the eardrum 29. The shape of the housing 14 of the first unit 11 is fitted to the shape of the auditory canal 27 in the desired section.

The second unit 12 is situated directly adjacent to the first unit 11 in the direction toward the exit of the auditory canal 27. The casing 20 of the second unit 12 does not close off the auditory canal 27, and so sound can reach the microphone 15 of the first unit 11, situated in the housing 14, through the auditory canal 27. Stabilizing elements (not illustrated) can be used to stabilize the second unit 12 in the illustrated position in the auditory canal 27. The first unit 11 can also contribute thereto with its housing 14, because the casing 20 is mechanically coupled to the housing 14.

The third unit 13 can be worn behind the auricle 28 or in the auricle or on the auricle. In the present example, the housing 22 including the casing 25 has a hook-shaped configuration and is hooked into the concha 30. The housing 22 then projects downward between antihelix and antitragus. It can be seen that the two casings 20 and 25 are situated directly opposite one another such that good inductive coupling is ensured between the respective coils 18 and 23.

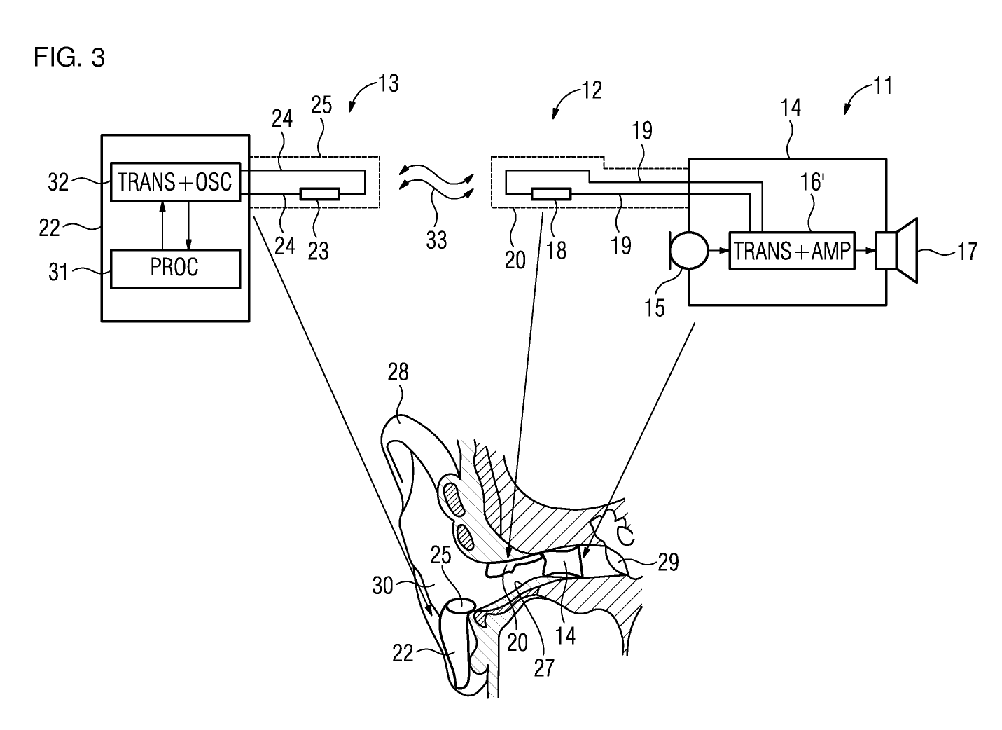

FIG. 3 shows an alternative embodiment of the hearing device according to the invention. The configuration of this hearing device substantially corresponds to that from FIG. 2, and so reference is made to the description of FIG. 2 in respect of the individual components and reference signs. However, the difference between the two embodiments consists of the fact that the hearing device or the hearing aid in FIG. 3 has an external processor 31 and is able to conduct bidirectional data interchange. Apart from the actual amplifier (AMP), the amplifier unit 16′ does not have a processor per se, but instead has a data transmission apparatus (TRANS). In this case, the hearing device processor 31 is integrated into the third unit 13, which is arranged outside of the auditory canal; this is why it is also referred to as an external processor. In order to be able to interchange data between the first unit 11 and the third unit 13, the third unit 13 also has a transmission apparatus 32 (TRANS). The transmission apparatus 32 has a bidirectional connection to the processor 31 (PROC) in the housing 22. Moreover, like in the example of FIG. 2, the transmission apparatus 32 is configured to invert the DC voltage of the battery (not illustrated) such that, like in the example of FIG. 2, energy can be transmitted from the third unit 13 to the second unit 12 and the first unit 11. Hence there is a bidirectional inductive coupling 33 between the two coils 18 and 23. As mentioned, this inductive interface can be used for wireless transmission of energy from the third unit 13 to the second unit 12. Moreover, it is also possible to transmit electrical signals from the microphone 15 of the first unit 11 to the processor 31 via the amplifier unit 16′, the wireless interface with coil 18, the inductive coupling 33 and coil 23, and also the transmission apparatus 32. After processing, the signals are transmitted back over the same path to the amplifier apparatus 16′ of the first unit 11, where they are amplified and output to the receiver 17.

The following text presents advantages and further alternatives of the hearing device according to the invention. The part of the hearing device fitted deep into the auditory canal, i.e. the units 11 and 12, has a completely passive design. Thus, these parts do not have a battery or another form of energy source. By way of example, this part merely contains a microphone, an amplifier and a receiver, integrated into the housing, with an earpiece, ear mold or dome for comfortable wear. While the passive part is housed deep in the ear canal, there is an energy store situated outside of the auditory canal—to be precise the third unit 13—and both parts are connected wirelessly by an electromagnetic field. The advantages of this configuration lie firstly in the fact that the part inserted deep into the auditory canal can have a substantially smaller configuration and, secondly, there is no need to remove the deep-fitted part from the ear canal when the battery needs to be replaced because the latter is seated in the external part (ability to wear the hearing aid for a long time). In the process, it is particularly advantageous if use is made of silicon microphones, which are very robust against moisture in the ear canal. A further advantage of the two-part nature of the hearing system consists of the fact that the externally worn part of the hearing aid, including the battery, can have a less conspicuous configuration, e.g. as a flat part behind the ear or with a jewel-like housing. It is also advantageous that the outer part can easily be charged or replaced when necessary.

As explained in the context of the second exemplary embodiment as per FIG. 3, it is possible not only to transmit energy in this case, but also to transmit data to the part of the hearing aid inserted deep into the auditory canal. By way of example, program-switch commands or volume-change commands are generated in the outer part following instigation by the user and are transmitted to the inner part. Parameters can be transmitted to the actual hearing aid, i.e. the part situated in the auditory canal, in this way, even during the fitting process.

Another variant, as explained in conjunction with FIG. 3, consists of the fact that the processor was moved from the inner part to the outer part of the hearing aid. For the interface, use can be made of technologies known from the field of RFID.

In another variant of the hearing device according to the invention, the casing of the antenna, more particularly an air-cored coil, has an annular configuration. However, it is also possible to use a ferrite core coil for the transmission.

The antenna casing 20 can also be provided with a projection or pulling element in order to pull the inner part of the hearing aid, i.e. the first unit 11 with the second unit 12, from the auditory canal 27.

The outer part of the hearing device, i.e. the third unit 13, can be placed anywhere on the auricle, provided that the two coils 23, 18 of the outer part and the inner part are directed at one another for maximal coupling. The outer part 13 can have any type of coil. By way of example, use can also be made here of a ferrite core coil or an air-cored coil. The coil 23 casing may likewise be annular, or else it may be cylindrical, and the coil can be worn visibly within the auricle 28 or behind the auricle. Moreover, use can be made of ferrite materials or other magnetically active materials in order to shape the magnetic field for improved magnetic coupling.

1. A hearing device, comprising:
a first unit which can be completely inserted within a human auditory canal, said first unit having a sound-recording element, a receiver, an amplifier connected between said sound-recording element and said receiver, and a first housing, said sound-recording element, said receiver and said amplifier integrated in said first housing; and
a second unit disposed outside of said first housing and can be inserted into the human auditory canal in addition to said first unit, said second unit galvanically connected to said first unit, said second unit configured for wireless energy absorption and for supplying said first unit with current.

2. The hearing device according to claim 1, wherein said sound-recording element is a silicon microphone.

3. The hearing device according to claim 1, wherein said second unit is configured for wireless data transmission.

4. The hearing device according to claim 3, wherein commands can be received wirelessly by said second unit, and the commands can be carried out by said first unit.

5. The hearing device according to claim 3, wherein said second unit is configured for wireless reception of adjustment parameters for said first unit.

6. The hearing device according to claim 1, further comprising a third unit physically separated from said first unit and said second unit, said third unit can be worn in or on an outer ear, and is configured for wireless emission of energy to said second unit.

7. The hearing device according to claim 6, wherein said third unit has a processor and a bidirectional data interchange between said first unit and said third unit is made possible via said second unit such that raw data from said first unit can be processed in said third unit and processed data can be transmitted back to said first unit.

8. The hearing device according to claim 1, wherein said second unit has an annular antenna with an air-cored coil.

9. The hearing device according to claim 1, wherein said second unit has a casing with a handle section, by means of which said first and second units can be pulled out of the human auditory canal.
